(19) United States
(12) Patent Application Publication
(10) Pub. No.: US 2023/0411593 A1
(43) Pub. Date: Dec. 21, 2023

(54) ANODE LAYER FOR ALL-SOLID-STATE SECONDARY BATTERY, ALL-SOLID-STATE SECONDARY BATTERY COMPRISING SAME, AND METHOD FOR MANUFACTURING ALL-SOLID-STATE SECONDARY BATTERY

(71) Applicant: SAMSUNG SDI CO., LTD., Yongin-si, Gyeonggi-do (KR)

(72) Inventors: Yunchae JUNG, Yongin-si, Gyeonggi-do (KR); Jinkyu KIM, Yongin-si, Gyeonggi-do (KR); Jinhoon YANG, Yongin-si, Gyeonggi-do (KR); Byeonggyu CHO, Yongin-si, Gyeonggi-do (KR); Sangil HAN, Yongin-si, Gyeonggi-do (KR)

(21) Appl. No.: 18/013,740

(22) PCT Filed: Nov. 26, 2021
(86) PCT No.: PCT/KR2021/017648

§ 371 Date: Dec. 29, 2022

(30) Foreign Application Priority Data
Feb. 10, 2021 (KR) 10-2021-0019358

(51) Int. Cl. H01M 4/134; H01M 4/38; H01M 10/0562

(52) U.S. Cl. CPC H01M 4/134; H01M 4/38; H01M 10/0562; H01M 2004/027

(57) ABSTRACT

Disclosed are an anode layer for an all-solid-state secondary battery, an all-solid-state secondary battery including the same, and a method of preparing the all-solid-state secondary battery. The anode layer for an all-solid-state secondary battery includes an anode current collector and a porous metal-based anode active material sheet positioned on the anode current collector, wherein the porous metal-based anode active material sheet is capable of precipitating lithium into the sheet during charging and the porous metal-based anode active material sheet may have a porosity of 30% to 90%.

### TECHNICAL FIELD

The disclosure relates to an anode layer for an all-solid-state secondary battery, an all-solid-state secondary battery including the same, and a method of preparing the all-solid-state secondary battery.

### BACKGROUND ART

In line with recent requirements in industry, batteries with high energy density and stability are actively being developed. For example, lithium-ion batteries are commercialized not only in the fields related to information-related devices and communication devices, but also in the automobile industry. In the automobile industry, safety is greatly emphasized as it affects human lives. Lithium-ion batteries currently commercially available utilize liquid electrolytes between a cathode layer and an anode layer, and thus, in the event of a short-circuit, may undergo overheating and cause a fire. In this context, an all-solid-state battery using a solid electrolyte instead of a liquid electrolyte layer is proposed. By not using a liquid electrolyte layer, the all-solid-state battery may significantly decrease the risk of fire or explosion even in the event of a short-circuit. Therefore, such all-solid-state batteries may be significantly safer than lithium-ion batteries using a liquid electrolyte layer. It is known that an anode active material layer containing a metal and a carbon-based material is used as an anode layer of an all-solid-state battery. However, such an anode layer may undergo dendrite growth, an increase in thickness thus causing a decrease in energy density, and give rise to an increase in resistance of electrode plates, and therefore, such an anode layer may require improvements in the aforementioned regards.

### DESCRIPTION OF EMBODIMENTS

One aspect of the disclosure provides an anode layer for an all-solid-state secondary battery, which has a reduced change in thickness of an anode layer during charging/discharging or/and after charging/discharging.

Another aspect provides an all-solid-state secondary battery having improved lifespan characteristics.

Another aspect provides a method of preparing the all-solid-state secondary battery.

### Solution to Problem

According to one aspect,
provided is an anode layer for an all-solid-state secondary battery, the anode layer including:
an anode current collector and a porous metal-based anode active material sheet positioned on the anode current collector,
wherein the porous metal-based anode active material sheet is capable of precipitating lithium into the sheet during charging, and
the porous metal-based anode active material sheet has a porosity of 30% to 90%.

According to another aspect of the disclosure, provided is a lithium battery including:
the anode layer;
a cathode layer; and
a solid electrolyte layer positioned between the anode layer and the cathode layer.

According to another aspect of the disclosure, a method of preparing an all- solid-state secondary battery includes:
providing an anode layer including an anode current collector and a porous metal-based anode active material sheet;
providing a solid electrolyte layer by coating and drying, on a release film, a solid electrolyte layer forming composition comprising a solid ion conductor and a binder;
providing a cathode layer; and
stacking the anode layer, the solid electrolyte layer and the cathode layer to thereby prepare the all-solid-state secondary battery according to claim 9.

### Advantageous Effects of Disclosure

An anode layer for an all-solid-state secondary battery according to one aspect includes a porous metal-based anode active material sheet on an anode current collector, wherein the porous metal-based anode active material sheet is capable of precipitating lithium into the sheet during charging. The anode layer for an all-solid-state secondary battery may significantly reduce the thickness of the anode layer, and as pores of the sheet act as lithium precipitation sites, changes in the thickness of the anode layer during charging/discharging or/and after charging/discharging may be reduced. An all-solid-state secondary battery including the anode layer may have improved lifespan characteristics.

### BRIEF DESCRIPTION OF DRAWINGS

FIG. 1 is a cross-sectional diagram showing of an anode layer for an all-solid-state secondary battery according to an exemplary embodiment, before and after charging.

FIG. 2 is a cross-sectional diagram showing an all-solid-state secondary battery according to an exemplary embodiment, before and after charging.

### MODE OF DISCLOSURE

Hereinbelow, with reference to embodiments and drawings of the present invention, an anode layer for an all-solid-state secondary battery, an all-solid-state secondary battery including the anode layer, and a method of the all-solid-state secondary battery will be described in greater detail. The following examples are for illustrative purposes only to describe the present disclosure in greater detail, and it will be apparent to those skilled in the art that these examples should not be construed as limiting the scope of the present disclosure.

Unless otherwise defined, all technical and scientific terms used herein have the same meaning as commonly understood by one of ordinary skill in the technical field to which the present application belongs. In the case of any inconsistencies, the present disclosure, including any definitions therein will prevail.

Methods and materials similar or equivalent to those described herein may be used in implementation or experiments of the present disclosure, but suitable methods and materials are described herein. As used herein, the singular forms are intended to include the plural forms as well, unless the context clearly indicates otherwise.

As used herein, the terms “comprises” and/or “comprising,” or “includes” and/or “including” should be understood to specify the presence of stated features, regions, integers, steps, operations, elements, components, ingredients, materials, or combinations thereof, but do not preclude the presence or addition of one or more other features, regions, integers, steps, operations, elements, components, ingredients, materials, or combinations thereof.

As used herein, the term “a combination thereof” refers to a mixture or combination of one or more of the described components.

As used herein, the term “and/or” includes any and all combinations of one or more of the associated listed items. The term “or” as used herein means “and/or”. Expressions such as “at least one” and “one or more” as used herein, when preceding a list of elements, may modify the entire list of elements and do not modify the individual elements of the list.

In the drawings, the thicknesses of layers and regions may be exaggerated for clarity of description. Like reference numerals denote like elements throughout the specification. Throughout the specification, when a component, such as a layer, a film, a region, or a plate, is described as being “above” or “on” another component, the component may be directly above the another component, or there may be yet another component therebetween. Throughout the specification, it will be understood that although the terms “first,” “second,” etc. may be used herein to describe various elements, these elements should not be limited by these terms. These terms are only used to distinguish one element from another element.

These terms are only used to distinguish one element from another element. Methods of using lithium metal as such include using lithium metal as an anode active material layer, or forming a lithium-precipitating layer on an anode current collector. The lithium-precipitating layer is required to have high conductivity and low interfacial resistance. A method of using a carbon layer as the lithium-precipitating layer is known. However, since an anode layer including a lithium-precipitating layer that utilizes a carbon layer tends to exhibit a severe change in thickness during charging/discharging of the all-solid-state battery, a buffer design is required in the design of an all-solid-state battery.

In this context, to address the aforementioned issues, the present inventors propose, as follows, an anode layer for an all-solid-state secondary battery, an all-solid-state secondary battery including the anode layer, and a method of preparing the all-solid-state secondary battery.

### Anode Layer for All-Solid-State Secondary Battery

An anode layer for an all-solid-state secondary battery according to an embodiment includes an anode current collector and a porous metal-based anode active material sheet on the anode current collector, wherein the porous metal-based anode active material sheet is capable of precipitating lithium into the sheet during charging.

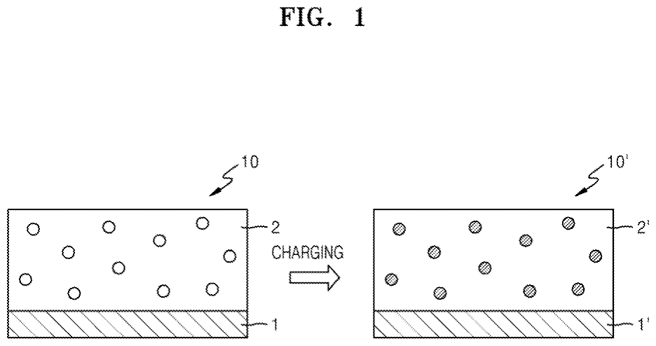

Referring to FIG. 1, an anode layer 10 for an all-solid-state secondary battery includes an anode current collector 1 and a porous metal-based anode active material sheet 2 positioned on the anode current collector 1. The anode layer 10 for an all-solid-state secondary battery, during charging, forms LiX (X is a metal e.g., Zn) within a charge capacity calculated as mass x charge capacity density of the porous metal-based anode active material sheet 2, and once this charge capacity is exceeded, lithium is precipitated into the pores. Here, the charge capacity density of the porous metal-based anode active material sheet 2 is a capacity estimated using an all-solid half-cell that uses lithium metal as the counter electrode. The charge capacity of the porous metal-based anode active material sheet 2 is directly measured by a measurement using an all-solid half-cell. Dividing this charge capacity by the mass of the porous metal-based anode active material sheet 2 gives the charge capacity density. The charge capacity of the porous metal-based anode active material sheet 2 may be an initial charge capacity measured during charging in the first cycle. An anode layer 10′ for an all-solid-state secondary battery may provide the anode layer 10′ for an all-solid-state secondary battery, which includes a porous metal-based anode active material sheet 2′ having lithium precipitated in pores. The anode layer 10 for an all-solid-state secondary battery may achieve a remarkable reduction in the thickness of the anode layer, as well as reduction in changes in the thickness of the anode layer during charging/discharging or/and after charging/discharging. As a result, an all-solid-state secondary battery including the anode layer 10 for an all-solid-state secondary battery may have improved lifespan characteristics.

The anode current collector 1 is formed of a material that does not react with lithium, that is, does not form alloys or compounds with lithium. Examples of the material forming the anode current collector 1 include copper (Cu), stainless steel (SUS), titanium (Ti), iron (Fe), cobalt (Co), nickel (Ni), and the like, but are not limited to aforementioned examples and may be any material available as an anode current collector 1 in the art. The anode current collector 1 may be formed of one type of metal of the aforementioned metals, an alloy of two or more types of metals thereof, or a coating material. For example, the anode current collector 1 is a plate type or a foil type.

The anode layer 10, 10′ for an all-solid-state secondary battery includes the porous metal-based anode active material sheet 2, 2′ on the anode current collector 1 and as such, has a structure capable of uniform lithium precipitation. The porous metal-based anode active material sheet 2, 2′ may have a porosity of 30% to 90%. For example, the porosity of the porous metal-based anode active material sheet 2, 2′ may be from 30% to 70%. When the porosity of the porous metal-based anode active material sheet 2, 2′ exceeds 90%, mechanical strength of the anode layers 10, 10′ for an all-solid-state secondary battery may deteriorate. When the porosity of the porous metal-based anode active material sheet 2, 2′ is less than 30%, lithium precipitation into the pores of the porous metal-based anode active material sheet 2, 2′ may not be facilitated. If a porous carbon-based anode active material sheet capable of lithium precipitation is used, the anode layer undergoes a severe change in thickness during charging and discharging of the all-solid-state secondary battery. Therefore, an all-solid-state secondary battery including a porous carbon-based anode active material requires a structural design that can buffer thickness changes of anode layer during charging and discharging.

The porous metal-based anode active material sheet 2, 2′ may include bismuth (Bi), tin (Sn), silicon (Si), zinc (Zn), silver (Ag), gold (Au), or an alloy thereof. The porous metal-based anode active material sheet 2, 2′ is a porous conducting material sheet including the metal or the alloy. The porous metal-based anode active material sheet 2, 2′ may be a three-dimensional porous structure.

The porous metal-based anode active material sheet 2, 2′ may have a thickness of 5 μm to 300 μm. When the thickness of the porous metal-based anode active material sheet 2, 2′ is within the above ranges, the battery may be commercialized without deterioration in battery performance.

### All-Solid-State Secondary Battery

A solid-state secondary battery according to an embodiment may include the above-described anode layer; a cathode layer; and a solid electrolyte layer between the anode layer and the cathode layer.

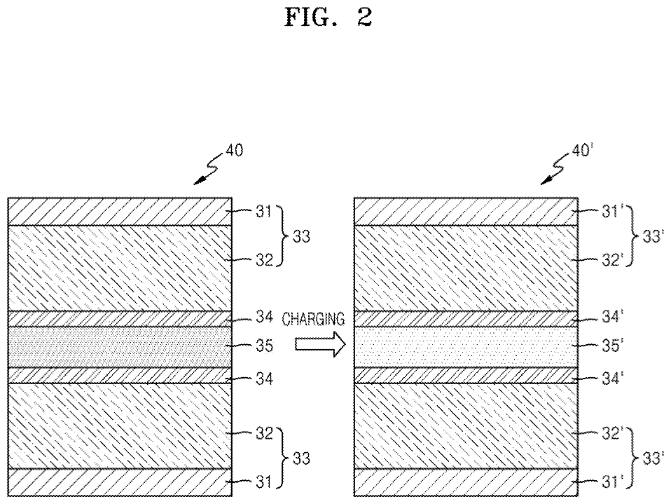

Referring to FIG. 2, an all-solid-state secondary battery 40 has sequentially arranged therein an anode layer 35 including an anode current collector and a porous metal-based anode active material sheet, a solid electrolyte layer 34, and a cathode layer 33 including a cathode current collector 31 and a cathode active material layer 32. The all-solid-state secondary battery 40 is capable of lithium precipitation into the porous metal-based anode active material sheet of the anode layer 35 during charging. The all-solid-state secondary battery 40 may have sequentially arranged therein, an anode layer 35′ including an anode current collector and a porous metal-based anode active material sheet having lithium precipitated in pores, a solid electrolyte layer 34′, and a cathode layer 33′ including a cathode current collector 31′ and a cathode active material layer 32′. Such an all-solid-state secondary battery 40 as described above may significantly reduce the thickness of the anode layer, and as the pores of the sheet act as lithium precipitation sites, changes in the thickness of the anode layer may be reduced during charging/discharging or/and after charging/discharging. The all-solid-state secondary battery 40 may have improved lifespan characteristics.

The solid electrolyte layer 34, 34′ may include a sulfide-based solid electrolyte.

The sulfide-based solid electrolyte may include an argyrodite-type solid electrolyte represented by Formula 1:

Li⁺₁₂₋ₙ₋ₓAⁿ⁺X²⁻₆₋ₓY³¹ₓ Formula 1

In Formula 1,

A may be P, As, Ge, Ga, Sb, Si, Sn, Al, In, Ti, V, Nb, or Ta,

X may be S, Se, or Te, Y may be Cl, Br, I, F, CN, OCN, SCN, or N₃, and 1≤n≤5 and 0≤x≤2 may be satisfied.

For example, the argyrodite-type solid electrolyte may be at least one selected from among Li₇₋ₓPS₆₋ₓClₓ wherein 0≤x≤2, Li₇₋ₓPS₆₋ₓBrₓ wherein 0≤x≤2, and Li₇₋ₓPS₆₋ₓIₓ wherein 0≤x≤2.

The argyrodite-type solid electrolyte may have a density of 1.5 g/cc to 2.0 g/cc. As the argyrodite-type solid electrolyte has a density of 1.5 g/cc or more, the all-solid-state secondary battery 40 may have a reduced internal resistance and penetration to the solid electrolyte layer 34, 34′ by lithium may be effectively inhibited.

The sulfide-based solid electrolyte may have an elastic modulus, that is, Young's modulus, of 35 GPa or less, 30 GPa or less, 27 GPa or less, 25 GPa or less, or 23 GPa or less, for example. The elastic modulus, that is, Young's modulus of the sulfide-based solid electrolyte may be for example, in a range of 10 GPa to 35 Gpa, 10 GPa to 30 Gpa, 10 GPa to 27 Gpa, 10 GPa to 25 Gpa, or 10 GPa to 23 GPa. As the sulfide-based solid electrolyte has an elastic modulus in the above ranges, the temperature and/or pressure required for sintering and the like may be decreased, thus further facilitating the sintering of solid electrolyte.

The solid electrolyte layer 34, 34′ may further include one or more of a binder or a lithium salt.

Examples of the binder include, but are not limited to styrene butadiene rubber (SBR), polytetrafluoroethylene, polyvinylidene fluoride, polyethylene, and the like, and any material available as a binder in the art may be used. The binder of the solid electrolyte layer 34, 34′ may be the same as or different from a binder included in the cathode active material layer 32, 32′.

Examples of the lithium salt may include LiSCN, LiN(CN)₂, Li(CF₃SO₂)₃C, LiC₄F₉SO₃, LiN(SO₂CF₂CF₃)₂, LiCl, LiF, LiBr, Lil, LiB(C₂O₄)₂, LiBF₄, LiBF₃(C₂F₅), lithium bis(oxalato)borate (LiBOB), lithium oxalyldifluoroborate (LIODFB), lithium difluoro(oxalato)borate (LiDFOB), lithium bis(trifluoro methanesulfonyl)imide, LiTFSI, LiN(SO₂CF₃)₂), lithium bis(fluorosulfonyl)imide, LiFSI, LiN(SO₂F)₂), LiCF₃SO₃, LiAsF₆, LiSbF₆, LiClO₄, or a mixture thereof. For example, the lithium salt may be an imide-based lithium salt, and examples of the imide-based lithium salt may include lithium bis(trifluoro methanesulfonyl)imide, LiTFSI, LiN(SO₂CF₃)₂, lithium bis(fluorosulfonyl)imide, LiFSI, and LiN(SO₂F)₂.

If necessary, the solid electrolyte layer 34, 34′ may further include an additive such as a filler, a coating agent, a dispersing agent, an ion conducting aid, and the like.

The cathode layer 33, 33′ includes a cathode current collector 31, 31′ and a cathode active material layer 32, 32′.

The cathode current collector 31, 31′ may use, for example, a plate, a foil, or the like formed of indium (In), copper (Cu), magnesium (Mg), stainless steel (SUS), titanium (Ti), iron (Fe), cobalt (Co), nickel (Ni), zinc (Zn), aluminum (Al), germanium (Ge), lithium (Li), or an alloy thereof. The cathode current collector 31, 31′ may be omitted.

The cathode current collector 31, 31′ may further include a carbon layer on one side or both sides of a metal substrate. Additional disposition of the carbon layer on the metal substrate may protect a metal in the metal substrate from being corroded by a solid electrolyte included in the cathode layer 33, 33′, and may reduce interfacial resistance between the cathode active material layer 32, 32′ and the cathode current collector 31, 31′. The carbon layer may have a thickness of 1 μm to 5 μm, for example. If the thickness of the carbon layer is excessively small, it may be difficult to completely block the contact between the metal substrate and the solid electrolyte. If the thickness of the carbon layer is excessively large, energy density of the all-solid-state secondary battery 40 may deteriorate. The carbon layer may include amorphous carbon, crystalline carbon, or the like.

The cathode active material layer 32, 32′ may include a cathode active material and a solid electrolyte.

The cathode active material is a compound capable of reversible absorption and desorption of lithium ions. Examples of the cathode active material include: lithium transition metal oxides such as lithium cobalt oxide (LCO), lithium nickel oxide, lithium nickel cobalt oxide, lithium nickel cobalt aluminum oxide (NCA), lithium nickel cobalt manganese oxide (NCM), lithium manganate, lithium iron phosphate, and the like; and nickel sulfide, copper sulfide, lithium sulfide, iron oxide, vanadium oxide, and the like. The cathode active material is not limited to the aforementioned examples and may be any material available as a cathode active material in the art. The cathode active material may be a single material or a mixture of two or more materials.

The lithium transition metal oxide may be, for example, a compound represented by any one of the following formulas: LiₐA_{1-b}B′_{b}D′₂ (In the formula, 0.90≤a≤1 and 0≤b≤0.5); LiₐE_{1-b}B′_{b}O_{2-c}D′_{c} (In the formula, 0.90≤a≤1, 0≤b≤0.5, 0≤c≤0.05); LiE_{2-b}B′_{b}O_{4-c}D′_{c} (In the formula, 0≤b≤0.5 and 0≤c≤0.05); LiₐNi_{1-b-c}Co_{b}B′_{c}D′_{α} (In the formula, 0.90≤a≤1, 0≤b≤0.5, 0≤c≤0.05, and 0<α≤2); LiₐNi_{1-b-c}Co_{b}B′_{c}O_{2-α}F′_{α} (In the formula, 0.90≤a≤1, 0≤b≤0.5, 0≤c≤0.05, and 0<α<2); LiₐNi_{1-b-c}Co_{b}B′_{c}O_{2-α}F′₂ (In the formula, 0.90≤a≤1, 0≤b≤0.5, 0≤c≤0.05, and 0<α<2); LiₐNi_{1-b-c}Mn_{b}B′_{c}D′_{α} (In the formula, 0.90≤a≤1, 0≤b≤0.5, 0≤c≤0.05, and 0<α≤2); LiₐNi_{1-b-c}Mn_{b}B′_{c}O_{2-α}F′_{α} (In the formula, 0.90≤a≤1, 0≤b≤0.5, 0≤c≤0.05, and 0<α<2); LiₐNi_{1-b-c}Mn_{b}B′_{c}O_{2-α}F′₂ (In the formula, 0.90≤a≤1, 0≤b≤0.5, 0≤c≤0.05, and 0<α<2); LiₐNi_{b}E_{c}G_{d}O₂ (In the formula, 0.90≤a≤1, 0≤b≤0.9, 0≤c≤0.5, and 0.001≤d≤0.1); LiₐNi_{b}Co_{c}Mn_{d}GeO₂ (In the formula, 0.90≤a≤1, 0≤b≤0.9, 0≤c≤0.5, 0≤d≤0.5, and 0.001≤e≤0.1); LiₐNiG_{b}O₂ (In the formula, 0.90≤a≤1 and 0.001≤b≤0.1); LiₐCoG_{b}O₂ (In the formula, 0.90≤a≤1 and 0.001≤b≤0.1); LiₐMnG_{b}O₂ (In the formula, 0.90≤a≤1 and 0.001≤b≤0.1); LiₐMn₂G_{b}O₄ (In the formula, 0.90≤a≤1 and 0.001≤b≤0.1); QO₂; QS₂; LiQS₂; V₂O₅; LiV₂O₅; LiI′O₂; LiNiVO₄; Li_{(3-f)}(PO₄)₃ (0≤f≤2); Li_{(3-f)}Fe₂(PO₄)₃ (0≤f≤2); and LiFePO₄. In the above- described compound, A may be Ni, Co, Mn, or a combination thereof; B′ may be Al, Ni, Co, Mn, Cr, Fe, Mg, Sr, V, a rare-earth element, or a combination thereof; D′ may be O F, S, P, or a combination thereof; E may be Co, Mn, or a combination thereof; F′ may be F, S, P, or a combination thereof; G may be Al, Cr, Mn, Fe, Mg, La, Ce, Sr, V, or a combination thereof; Q may be Ti, Mo, Mn, or a combination thereof; I′ may be Cr, V, Fe, Sc, Y, or a combination thereof; and J may be V, Cr, Mn, Co, Ni, Cu, or a combination thereof. A compound having a coating layer added on a surface of the above-described compound may also be used, and a mixture of the above compound and a compound having a coating layer added thereon may also be used. The coating layer added on the surface of the above-described compound includes, for example, compounds of a coating element, such as oxides and hydroxides of the coating element, oxyhydroxides of the coating element, oxycarbonates of the coating element, and hydroxycarbonates of the coating element. Compounds forming the above coating layer may be amorphous or crystalline. The coating element included in the coating layer may be Mg, Al, Co, K, Na, Ca, Si, Ti, V, Sn, Ge, Ga, B, As, Zr, or a mixture thereof. The method of forming a coating layer may selected from methods that do not adversely affect the physical properties of cathode active material. Examples of a coating method may include spray coating, dip coating, and the like. Specific coating methods are well known by those of ordinary skill in the art, and therefore detailed descriptions thereof will be omitted.

The cathode active material may include a lithium composite oxide represented by Formula 2:

LiₓNi_{1-y-z}M_{y}Co_{z}O₂ Formula 2

In Formula 2,

0.90≤x≤1.1, 0≤y≤0.2, 0<z≤0.2, and 0.7≤1−y−z≤0.99 may be satisfied, and

M may be Mn, Al, Ti, Ca, or a combination thereof.

The cathode active material may be a lithium composite oxide having a layered rock-salt type structure. The all-solid-state secondary battery 40 including such a cathode active material as described above may have further improved energy density and thermal stability. In addition, inclusion of the above-described cathode active material may increase the capacity density of the all-solid-state secondary battery 40 in a charged state to thereby reduce metal dissolution from the cathode active material. As a result, improvement in lifespan characteristics of the all-solid-state secondary battery 40 in a charged state may be achieved.

The lithium composite oxide may have a lithium transition metal oxide coating layer positioned on a surface thereof. For example, the lithium transition metal oxide may be an oxide including lithium and at least one transition metal selected from among Al, Ni, Co, Mn, Cr, Fe, Mg, Mo, Sc), V, Ti, Cu, Zr, or a combination thereof. The above-described lithium composite oxide may further improve capacity and lifespan characteristics of the all-solid-state secondary battery 40.

The shape of the cathode active material has a particle shape, such as a perfect sphere, an oval sphere, and the like. The particle diameter of the cathode active material is not particularly limited, and is within a range applicable to a conventional solid-state secondary battery 40 in the art. Also, the content of the cathode active material in a cathode layer 33, 33′ is not particularly limited, and is within a range applicable to the cathode layer 33, 33′ of a conventional solid-state secondary battery 40 in the art.

A solid electrolyte in the cathode active material layer 32, 32′ may include a sulfide-based solid electrolyte. For example, the solid electrolyte of the cathode active material layer 32, 32′ may include at least one sulfide-based solid electrolyte selected from among Li₇₋ₓPS₆₋ₓClₓ, wherein 0≤x≤2, Li₇₋ₓPS₆₋ₓBrₓ, wherein 0≤x≤2, and Li₇₋ₓPS₆₋ₓIₓ, wherein 0≤x≤2. The solid electrolyte of the cathode active material layer 32, 32′ may be the same as or different from a solid electrolyte in a solid electrolyte layer 34, 34′.

The cathode active material layer 32, 32′ may include a binder. Examples of the binder include styrene butadiene rubber (SBR), polytetrafluoroethylene, polyvinylidene fluoride, polyethylene, and the like.

The cathode active material layer 32, 32′ may further include a conducting agent. Examples of the conducting agent include graphite, carbon black, acetylene black, Ketjen black, carbon fibers, metal powder, and the like.

The cathode active material layer 32, 32′ may further include, for example, an additive such as a filler, a coating agent, a dispersing agent, an ion conducting aid, and the like in addition to the cathode active material, the solid electrolyte, the binder, and the conducting agent described above.

For the filler, the coating agent, the dispersing agent, the ion conducting aid, and the like that may be included in the cathode active material layer 32, 32′, a known material generally used in an electrode of the all-solid-state secondary battery 40 may be used.

### Method of Preparing All-Solid-State Secondary Battery

A method of preparing an all-solid-state secondary battery 40 according to an embodiment includes: providing an anode layer 35, 35′ including an anode current collector and a porous metal-based anode active material sheet; providing a solid electrolyte layer 34, 34′ by coating and drying a solid electrolyte layer forming composition on a release film, the solid electrolyte layer forming composition including a solid ion conducting material and a binder; providing a cathode layer 33, 33′; and stacking the anode layer 35, 35′, the solid electrolyte layer 34, 34′, and the cathode layer 33, 33′ to thereby prepare the above-described solid-state secondary battery 40.

In the providing an anode layer 35, 35′, the porous metal-based anode active material sheet is positioned on the anode current collector.

In the providing a solid electrolyte layer 34, 34′, the solid electrolyte layer 34, 34′ is prepared by coating and drying a solid electrolyte layer forming composition including a solid ion conducting material and a binder on a release film.

The providing a cathode layer 33, 33′ includes preparing the cathode layer 33, 33′ by coating and drying a composition including a cathode active material, a solid electrolyte, a conducting agent, a binder, and a solvent, on a cathode current collector 31, 31′.

The anode layer 35, 35′, the solid electrolyte layer 34, 34′, and the cathode layer 33, 33′ are stacked together to thereby form the above-described solid-state secondary battery 40.

The present disclosure will be described in greater detail through Examples and Comparative Examples below. However, it will be understood that the Examples are only for illustrating the present disclosure, and are not to be construed as limiting the scope of the present disclosure.

### EXAMPLES

### (All-Solid-State Secondary Battery)

### Example 1: Preparation of All-Solid-State Secondary Battery

### (Preparation of Anode Layer)

An SUS foil current collector having a thickness of 10 μm was placed on a bottom surface of a cell case. A zinc (Zn) foam having a porosity of 50% and a thickness of 100 μm was placed on one side of the SUS foil current collector, thereby forming an anode layer.

### (Preparation of Solid Electrolyte Layer)

2 wt % isobutyl isobutylate (IBIB) binder solution was added to an argyrodite-type Li₆PS₅Cl solid ion conductor pellet, and mixed together under stirring by a Thinky mixer while adjusting viscosity. The resulting mixture was combined with 2 mm zirconia balls and stirred again by a Thinky mixer, thereby forming a solid electrolyte layer forming slurry. The solid electrolyte layer forming slurry was cast upon a polyethylene terephthalate (PET) release film and dried at room temperature, thereby forming a solid electrolyte layer.

### (Preparation of Cathode Layer)

100 parts by weight of anhydrous 2-propanol, 10 parts by weight of lithium methoxide (10% methanol solution), and 0.5 parts by weight of zirconium (IV) tetrapropoxide were mixed together to prepare a lithium zirconium oxide (LZO) coating solution. The LZO coating solution was combined with a LiNi_{0.9}Co_{0.05}Mn_{0.05}O₂ (NCM) cathode active material, and mixed together by stirring for 1 hour. The resulting mixture was dried under vacuum at 50° C., thereby forming a LZO-coated LiNi_{0.9}Co_{0.05}Mn_{0.05}O₂ (NCM) cathode active material. The LZO-coated LiNi_{0.9}Co_{0.05}Mn_{0.05}O₂ (NCM) cathode active material as a cathode active material, an argyrodite-type Li₆PS₅Cl solid ion conductor pellet as a solid electrolyte, a carbon nanofiber (CNF) as a conducting agent, and polytetrafluoroethylene (PTFE) as a binder were mixed in a mass ratio of 81.3:14.4:2.9:1.4. Subsequently, the resulting mixture was mixed with xylene and then dried in a vacuum chamber at 45° C. for 2 hours, thereby forming a cathode layer having a thickness of 150 μm.

### (Preparation of All-Solid-State Secondary Battery)

The anode layer, the all-solid-state electrolyte layer, and the cathode layer were each punched to a circular shape having a diameter of 12 mm and then stacked together, thereby forming an all-solid-state secondary battery.

### Comparative Example 1: Preparation of All-Solid-State Secondary Battery

An all-solid-state secondary battery was prepared following the same process as Example 1, except that a copper (Cu) foam having a porosity of 50% and a thickness of 100 μm was placed on one side of the SUS foil current collector and used as the anode layer.

### Comparative Example 2: Preparation of All-Solid-State Secondary Battery

An all-solid-state secondary battery was prepared following the same process as Example 1, except that a zinc (Zn) foam having a porosity of 50% and a thickness of 100 μm was used as the anode layer, without using the SUS foil current collector.

### Comparative Example 3: Preparation of All-Solid-State Secondary Battery

Zinc (Zn) nanoparticles (D50:60 nm) as an anode active material, carbon black as a conducting agent, and polyvinylidene fluoride (PVdF) as a binder were combined in a mass ratio of 23.4:70.1:6.5, and mixed together under stirring by a Thinky mixer while adjusting viscosity. Here, the PVdF binder used was a solution prepared using N-methylpyrrolidone (NMP). The resulting mixture was combined with 2 mm zirconia balls and stirred again by a Thinky mixer, thereby forming an anode active material layer forming slurry. The anode active material layer forming slurry was coated on one side of an SUS foil current collector having a thickness of 10 μm, and was dried under vacuum at 100° C., thereby forming an anode layer having a thickness of 10 μm.

Except that the above anode layer was used, an all-solid-state secondary battery was prepared following the same process as Example 1.

### Comparative Example 4: Preparation of All-Solid-State Secondary Battery

An all-solid-state secondary battery was prepared following the same process as Example 1, except that, instead of using the SUS foil current collector, a zinc (Zn) foil with a thickness of 100 μm was used as the anode layer.

### Comparative Example 5: Preparation of All-Solid-State Secondary Battery

An all-solid-state secondary battery was prepared following the same process as Example 1, except that, instead of using the SUS foil current collector, a copper (Cu) foil with a thickness of 100 μm was used as the anode layer.

### Analysis Example 1: Thickness Change of Anode Layer of Battery After Charging

The all-solid-state secondary batteries prepared in Example 1 and Comparative Examples 1 to 5 were charged at 25° C. with a constant current (CC) of 0.33 C until the voltage reached 4.25 V, and then charged at a constant voltage (CV), and the charging process was performed until the charging current reached 0.1 C (cut-off current). Thereafter, under an argon (Ar) atmosphere, each solid-state secondary battery was cut and a cross-section thereof was polished using a cross-section polisher (Fischione M1040). Subsequently, the cross-section of each solid-state secondary battery was examined using a scanning electron microscope (SEM, HITACHI S4700) to observe a thickness change of the anode layer. The results thereof are shown in Table 1 below.

TABLE 1

| | Thickness change of anode layer (μm) |
|---|---|
| Example 1 | 1 |
| Comparative Example 1 | 3 |
| Comparative Example 2 | 1 |
| Comparative Example 3 | 5 |
| Comparative Example 4 | 35 |
| Comparative Example 5 | 50 |

As shown in Table 1, the all-solid-state secondary battery prepared in Example 1 shows a smaller thickness change of the anode layer after charging, compared to the thickness changes of the anode layers after charging in the all-solid-state secondary batteries prepared in Comparative Examples 1 to 5.

### Evaluation Example 2: Charge-Discharge Test

The all-solid-state secondary batteries prepared in Example 1 and Comparative Examples 1 to 5 were evaluated for charge-discharge characteristics by a charge-discharge test as follows. The charge-discharge test was performed with the all-solid-state secondary batteries placed in a constant-temperature bath at 45° C.

Each solid-state secondary battery was charged with a constant current (CC) of 0.33 C until the voltage reached 4.25 V and then charged at a constant voltage (CV), and one cycle charging process was performed until the charging current reached 0.1 C (cut-off current). Thereafter, each solid-state secondary battery was left alone for 10 minutes and then discharged with a constant current (CC) of 0.33 C until the voltage reached 2.5 V. Then, each solid-state secondary battery was fully charged following the same process as above, and the cycle numbers at which the discharge capacity vs. initial discharge capacity reached 80% and 50% are shown in Table 2.

TABLE 2

| | Cycle number at which initial discharge | |
|---|---|---|
| | capacity vs. remaining discharge | |
| | capacity (%) is measured | |
| | 80% | 50% |
| Example 1 | >100 | >100 |
| Comparative Example 1 | 10 | 11 |
| Comparative Example 2 | 81 | >100 |
| Comparative Example 3 | 5 | 5 |
| Comparative Example 4 | 17 | 20 |
| Comparative Example 5 | 12 | 13 |

As shown in Table 2, for the all-solid-state secondary battery prepared in Example 1, the cycle number at which the discharge capacity vs. initial discharge capacity reached 80% and 50% was more than 100 in both cases. For the all-solid-state secondary batteries prepared in Comparative Examples 1 to 5, the cycle number at which the discharge capacity vs. initial discharge capacity reached 80% and 50% was smaller than those of the all-solid-state secondary battery prepared in Example 1.

1. An anode layer for an all-solid-state secondary battery, the anode layer comprising:
an anode current collector: and
a porous metal or metalloid anode active material sheet on the anode current collector,
wherein:
the porous metal or metalloid anode active material sheet is capable of precipitating lithium into the sheet during charging, and
the porous metal or metalloid anode active material sheet has a porosity of 30% to 90%.

2. The anode layer of claim 1, wherein the porous metal or metalloid anode active material sheet has a porosity of 30% to 70%.

3. The anode layer of claim 1, wherein the porous metal or metalloid anode active material sheet includes bismuth (Bi), tin (Sn), silicon (Si), zinc (Zn), silver (Ag), gold (Au), or an alloy thereof.

4. The anode layer of claim 1, wherein the porous metal or metalloid anode active material sheet has a thickness of 5 μm to 300 μm.

5. An all-solid-state secondary battery, comprising:
an anode layer according to claim 1;
a cathode layer; and
a solid electrolyte layer between the anode layer and the cathode layer.

6. The all-solid-state secondary battery of claim 5, wherein the solid electrolyte layer includes a sulfide solid electrolyte.

7. The all-solid-state secondary battery of claim 6, wherein:
the sulfide solid electrolyte includes an argyrodite-type solid electrolyte represented by Formula 1:
Li⁺₁₂₋ₙ₋ₓAⁿ⁺X²⁻₆₋ₓY⁻ₓ Formula 1
in Formula 1,
A is P, As, Ge, Ga, Sb, Si, Sn, Al, In, Ti, V, Nb, or Ta,
X is S, Se, or Te, Y is Cl, Br, I, F, CN, OCN, SCN, or N₃, 1≤n≤5, and 0≤x≤2.

8. The all-solid-state secondary battery of claim 7, wherein the argyrodite-type solid electrolyte includes Li₇₋ₓPS₆₋ₓClₓ, in which 0≤x≤2, Li₇₋ₓPS₆₋ₓBrₓ, in which 0≤x≤2, or Li₇₋ₓPS₆₋ₓIₓ, in which 0≤x≤2.

9. The all-solid-state secondary battery of claim 5, wherein the solid electrolyte layer further includes at least one of a binder and a lithium salt.

10. The all-solid-state secondary battery of claim 5, wherein:
the cathode layer includes a cathode current collector and a cathode active material layer on the cathode current collector, and
the cathode active material layer includes a cathode active material and a solid electrolyte.

11. The all-solid-state secondary battery of claim 10, wherein:
the cathode active material includes a lithium composite oxide represented by Formula 2:
LiₓNi_{1-y-z}M_{y}Co_{z}O₂ Formula 2
in Formula 2
0.90≤x≤1.1, 0≤y≤0.2, 0≤z≤0.2, and 0.7≤1−y−z≤0.99, and
M is manganese (M), aluminum (Al), titanium (Ti), calcium (Ca), or a combination thereof.

12. The all-solid-state secondary battery of claim 11, wherein the lithium composite oxide has a lithium metal oxide coating layer on a surface thereof.

13. The all-solid-state secondary battery of claim 12, wherein the lithium metal oxide is an oxide including lithium and another metal, the other metal including aluminum (Al), nickel (Ni), cobalt (Co), manganese (Mn), chromium (Cr), iron (Fe), magnesium (Mg), molybdenum (Mo), scandium (Sc), vanadium (V), titanium (Ti), copper (Cu), zirconium (Zr), or a combination thereof.

14. The all-solid-state secondary battery of claim 10, wherein the solid electrolyte layer includes a sulfide solid electrolyte.

15. The all-solid-state secondary battery of claim 10, wherein the solid electrolyte includes a sulfide solid electrolyte, the sulfide solid electrode including Li₇₋ₓPS₆₋ₓClₓ, in which 0≤x≤2, Li₇₋ₓPS₆₋ₓBrₓ, in which 0≤x≤2, or Li₇₋ₓPS₆₋ₓIₓ, in which 0≤x≤2.

16. A method of preparing the all-solid-state secondary battery as claimed in claim 5, the method comprising:
providing an anode layer including an anode current collector and a porous metal or metalloid anode active material sheet;
providing a solid electrolyte layer by coating and drying, on a release film, a solid electrolyte layer forming composition including a solid ion conductor and a binder;
providing a cathode layer; and
stacking the anode layer, the solid electrolyte layer, and the cathode layer to thereby prepare the all-solid-state secondary battery.

17. The method of claim 16, wherein providing the cathode layer includes preparing a cathode layer by coating and drying a composition on a cathode current collector, the composition including a cathode active material, a solid electrolyte, a conducting agent, a binder, and a solvent.
